(19) United States
(12) Patent Application Publication
(10) Pub. No.: US 2013/0071759 A1
(43) Pub. Date: Mar. 21, 2013

(54) LITHIUM ION BATTERY

(71) Applicant: Takahiro YAMAKI, Hitachinaka (JP)

(72) Inventor: Takahiro YAMAKI, Hitachinaka (JP)

(73) Assignee: HITACHI, LTD., Tokyo (JP)

(21) Appl. No.: 13/589,419

(22) Filed: Aug. 20, 2012

(30) Foreign Application Priority Data
Sep. 21, 2011 (JP) 2011-205495

(51) Int. Cl. H01M 10/056; H01M 10/052

(52) U.S. Cl. 429/332; 429/188

(57) ABSTRACT

A lithium ion battery includes: a cathode that includes a cathode mix, which contains a cathode active material stably exhibiting a potential of 4.5 V or greater on the metallic lithium basis, a conducting material, and a binder, on a cathode collector; an anode; and a nonaqueous electrolyte that is obtained by dissolving a lithium salt in a nonaqueous solvent, in which a lithium fluoride is provided on at least a surface layer of the cathode collector.

### BACKGROUND OF THE INVENTION

1. Field of the Invention

The present invention relates to a high-voltage lithium ion battery in which a cathode is used at a potential of 4.5 V or greater on the metallic lithium basis.

2. Background Art

In recent years, as a power supply in which batteries are used in a multiple-series manner and which is used for an electric vehicle (EV), a Hybrid-EV, or power storage, or as a power supply in which energy density is relatively high, compared to a voltage of around 4 V in the related art, a high-voltage lithium ion battery is required.

In the high-voltage lithium ion battery, a cathode thereof contains a cathode material that stably exhibits a potential of 4.5 V or greater on the metallic lithium basis. As such cathode active materials, a transition metal substituted spinel Mn oxide that is expressed by a general formula of LiMn₂₋ₓMₓO₄ (M=Ni, Co, Cr, Fe, or the like), an olivine-based oxide (ordinary name) that is expressed by a general formula of LiMPO₄ (M=Ni or Co), and the like are known. Generally, the high-potential cathode is provided with a cathode mix containing a cathode material, a conducting material that increases conductivity, and a binder that binds these materials in a cathode collector such as aluminum foil through means such as coating. The high-voltage lithium ion battery includes the high-potential cathode, an anode, and a nonaqueous electrolyte containing a lithium salt.

In the lithium ion battery of a voltage around 4 V in the related art, a nonaqueous electrolyte in which a lithium salt is dissolved in a nonaqueous solvent containing a carbonate-based solvent as a main component has been widely used. As a specific example, a nonaqueous electrolyte, which is obtained by dissolving a lithium salt such as lithium hexafluorophosphate (LiPF₆) and lithium tetrafluoroborate (LiBF₄) in a mixed solvent of a cyclic carbonate having a high dielectric constant such as ethylene carbonate (EC) and propylene carbonate (PC), and linear carbonate such as dimethyl carbonate (DMC), diethyl carbonate (DEC), and methyl ethyl carbonate (MEC), is used. Characteristics of the electrolyte containing this carbonate-based solvent as a main component are that the balance of oxidation resistance and reduction resistance is excellent, and conductivity of lithium ions is excellent.

However, the lithium ion battery, which uses the high-potential cathode exhibiting a potential of 4.5 V or greater, has a problem of a cycle lifetime in which a decrease in a capacity and a coulombic efficiency (a ratio of a discharge capacity with respect to a charge capacity) is significant due to a charge and discharge cycle, compared to the lithium ion battery of around 4 V in the related art. As one cause of this problem, since the cathode has a high potential, oxidation decomposition of the above-described carbonate-based solvent on a surface of the cathode material, the conducting material, or the collector becomes significant. As another cause, since the cathode has a high potential, oxidation dissolution of metal elements such as aluminum that makes up the cathode collector becomes significant, and thus deterioration of the electrolyte or formation of a high-resistivity layer due to reductive precipitation in the anode may be considered.

As technologies in the related art to overcome this problem, for example, JP-A-2004-241339 discloses a lithium ion battery using a solvent in which a hydrogen atom making up carbonate is substituted with a halogen element such as fluorine. In addition, JP-A-2002-110225 discloses a lithium ion battery using a room-temperature melted salt. However, in an electrolyte using this solvent, there is a problem in that reduction resistance is inferior or lithium ion conductivity is inferior. Furthermore, an effect with respect to dissolution of the metal elements making up the cathode collector may not be anticipated.

In addition, as other technologies in the related art to overcome the above-described problem in the related art, countermeasures related to a cathode are disclosed. For example, JP-A-2009-218217 discloses a cathode material for a lithium ion battery, in which a coated layer containing a metal element is provided on a surface of the cathode material. In addition, JP-A-2009-104815 discloses a cathode material for a lithium ion battery, in which a halide is provided on the surface of the cathode material. However, since the oxidation decomposition of the solvent progresses also in the conducting material or collector that make up the cathode, it is apparent that an effect that is anticipated of these technologies is not sufficient. Furthermore, an effect with respect to dissolution of the metal elements making up the cathode collector may not be anticipated. In addition, JP-A-2003-173770 discloses a lithium ion battery in which the cathode active material and the conducting material are coated with lithium ion conductive glass. However, the coating of the conductive glass significantly deteriorates conductivity of lithium ions and thus there is a problem in that a battery performance is deteriorated.

As described above, in the lithium ion battery using the high-potential cathode that exhibits a potential of 4.5 V or greater, a problem with respect to the cycle lifetime is not yet solved sufficiently.

### SUMMARY OF THE INVENTION

An object of the invention is to provide a lithium ion battery that is excellent in a cycle lifetime.

According to an aspect of the invention, there is provided a lithium ion battery including: a cathode that includes a cathode mix, which contains a cathode material stably exhibiting a potential of 4.5 V or greater on the metallic lithium basis, a conducting material, and a binder, on a cathode collector; an anode; and a nonaqueous electrolyte that is obtained by dissolving a lithium salt in a nonaqueous solvent, in which a compound of lithium and fluorine is provided on a surface layer of the cathode collector.

According to the invention, a lithium ion battery that is excellent in a cycle lifetime may be obtained.

### BRIEF DESCRIPTION OF THE DRAWINGS

FIG. 1 is a diagram illustrating a difference in cyclic voltammetry according to whether or not a boron ethoxide is present in a nonaqueous electrolyte;

FIG. 2 is a schematic cross-sectional diagram of a cylindrical bundle of electrodes of a lithium ion battery of an embodiment of the invention; and

FIG. 3 is a diagram illustrating an example of an Li1s waveform and an F1s waveform of a surface of a cathode collector of the battery of the embodiment.

### DETAILED DESCRIPTION OF THE INVENTION

A lithium ion battery of an embodiment of the invention includes: a cathode that includes a cathode mix, which contains a cathode material stably exhibiting a potential of 4.5 V or greater on the metallic lithium basis, a conducting material, and a binder, on a cathode collector; an anode; and a nonaqueous electrolyte that is obtained by dissolving a lithium salt in a nonaqueous solvent. As an example of a type of a high-potential cathode is a cathode in which a cathode mix is applied onto a collector formed of aluminum. In addition, on a surface layer of an uncoated portion of the cathode collector in which the cathode mix is not provided, a compound of lithium and fluorine, preferably, a lithium fluoride is provided.

It is estimated that due to this surface layer, direct contact between the solvent of the electrolyte and the collector is suppressed, and thus oxidation decomposition of the solvent is suppressed. At the same time, it is estimated that dissolution of metal elements making up the cathode collector in the electrolyte is suppressed. Due to this operation, a high-voltage lithium ion battery that is excellent in a cycle lifetime may be obtained.

The surface layer may be provided on a surface of not only the cathode collector but also the cathode material or the conducting material. In this case, it may be anticipated that direct contact between the surface of the cathode material or the conducting material and the solvent of the electrolyte is suppressed.

Means for providing the surface layer is not particularly limited. For example, the cathode mix may be provided after a compound layer of lithium and fluorine is provided in advance to the cathode collector. In addition, the lithium ion battery may be configured after a raw material of the compound is provided to the cathode collector, and the compound layer of lithium and fluorine may be formed by performing charge and discharge of the battery.

Furthermore, an additive may be added to the nonaqueous electrolyte to make the additive react on the surface of the cathode so as to form the surface layer. In the means, the number of battery manufacturing processes is smaller compared to the former, and the surface layer may be uniformly formed not only on the cathode collector, but also on the surface of the cathode material or the conducting material. Therefore, this is more preferable. Two or more kinds of additives may be added.

Examples of the additive may include a boron ethoxide.

The boron ethoxide is expressed by a chemical formula of B(OC₂H₅)₃. In a nonaqueous electrolyte H to which the boron ethoxide is added, an oxidation reaction progresses at a cathode potential of approximately 4.5 V or greater, and at this time, a surface layer containing the compound of lithium and fluorine is formed on the surface of the cathode collector or the mix.

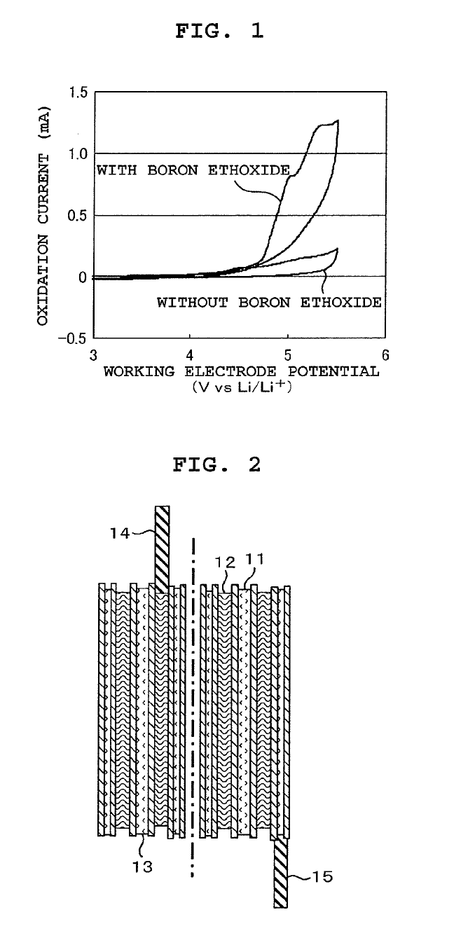

FIG. 1 shows a difference of cyclic voltammetry between a case in which 4% by weight of the boron ethoxide is added to a nonaqueous electrolyte that is obtained by dissolving 1 mol/dm³ of lithium hexafluorophosphate as a lithium salt in a nonaqueous mixed solvent containing ethylene carbonate, dimethyl carbonate, and methyl ethyl carbonate in a volume ratio of 2:4:4, that is, a case in which a boron ethoxide is present, and a case in which the boron ethoxide is not added to the nonaqueous electrolyte, that is, a case in which a boron ethoxide is not present. It can be seen that in the case where the boron ethoxide is present, an oxidation current rapidly increases to approximately 4.5 V or greater compared to the case where the boron ethoxide is not present.

A mechanism of forming the surface layer is not clear, but this is assumed as follows. When the boron ethoxide is added to the nonaqueous electrolyte, a part of fluorine ions in LiPF₆ or LiBF₄ that is the lithium salt is substituted with an ethoxy group (OC₂H₅) and thus a lithium salt derivative is generated. It is assumed that this derivative is oxidized on the surface of the cathode collector, the cathode material, or the conducting material, and thus the surface layer containing the compound of lithium and fluorine is formed thereon.

In regard to the lithium ion battery that is an embodiment of the invention, in measurement of X-ray photoelectron spectroscopy (XPS) on the uncoated portion of the cathode collector, an Li1s waveform is present, and in the Li1s waveform, a main peak is shown at 56 to 57.5 electron volts (eV). More preferably, in the XPS measurement, an F1s waveform is present, and in the F1s waveform, a main peak is shown at 685.5 to 686.5 electron volts (eV).

A description will be made with respect to the cathode collector formed of aluminum as an example. On a surface of aluminum that is the cathode collector, commonly, a thin layer of an aluminum oxide is present. When the charge and discharge is performed by using this thin layer as the collector of the lithium ion battery, a thin layer of an aluminum fluoride is also formed.

Here, when lithium is detected in the XPS measurement on the surface of the collector, it is considered that the lithium is present in the thin layer (surface layer) on the surface of the collector. In addition, it is considered that a bond of lithium and fluorine, which is stable even under a high-potential oxidization environment, is formed, and as a result thereof, a bonding energy in the Li1s is observed in 56 to 57.5 eV.

In addition, in a case where the bond of lithium and fluorine is present on the surface layer, the bonding energy in the F1s is observed in 685.5 to 686.5 eV.

In this embodiment, for example, the XPS measurement on the surface of the cathode collector is performed as follows. A lithium ion battery is disassembled in an inert atmosphere such as argon, and the cathode is taken out. The uncoated portion of the collector in which the cathode mix is not provided is cut in an appropriate size, and the uncoated portion that is cut is cleaned with the solvent making up the nonaqueous electrolyte, for example, dimethyl carbonate, or the like, and then this cleaned uncoated portion is dried. Then, the dried uncoated portion is conveyed into an XPS apparatus. At this time, it is preferable that a sample to be measured not be exposed to the air atmosphere.

Commonly, components of the solvent or a salt which are a residue after the cleaning, and impurities are adhered to an outermost surface of the sample. In the measurement, the sample is etched by irradiation of argon ions or the like, and the residue or the impurities are preferably removed. It is difficult to grasp an etched amount, but for example, it is preferable that the etching be performed under etching conditions corresponding to the removal of 1 to 5 nm in terms of a silicon oxide.

When an amount of lithium and fluorine that are present in the surface layer is small, or the surface layer is too thin, it is difficult to obtain a sufficient effect with respect to suppression of direct contact between the electrolyte and the collector, or suppression of dissolution of the metal elements making up the collector. On the other hand, when the amount of lithium and fluorine is too much, or the surface layer is too thick, diffusion of lithium ions into the surface layer is deteriorated and thus a battery performance may be deteriorated.

An appropriate amount of lithium and fluorine that are present in the surface layer may be set by using a measurement result about a proportion of an element by the XPS as an index. The lower detection limit of the element in the XPS is approximately 1% as the proportion of an element, and it is necessary for at least lithium and fluorine to be detected in the surface layer.

On the other hand, when the proportion of lithium and fluorine with respect to constituent elements of the collector that is an underlayer of the surface layer is too high, it can be ascertained that the surface layer becomes too thick and thus the battery performance may deteriorate. It is preferable that the proportion of lithium be ½ or less of that of the constituent elements of the collector that becomes the underlayer. In addition, it is preferable that the proportion of fluorine be equal to or less than that of the constituent elements of the collector that becomes the underlayer.

As the lithium salt making up the nonaqueous electrolyte, LiClO₄, LiCF₃SO₃, LiPF₆, LiBF₄, LiAsF₆, or the like may be used alone, or two or more may be used in combination. Since LiPF₆ has a high dissociation degree and is excellent in lithium ion conductivity, lithium hexafluorophosphate (LiPF₆) is more preferable. Furthermore, when the surface layer containing the compound of lithium and fluorine is formed by the addition of the boron ethoxide, it is preferable that the nonaqueous electrolyte contain LiPF₆ or LiBF₄.

In addition, when cyclic carbonate and linear carbonate are used as the nonaqueous solvent making up the nonaqueous electrolyte, since lithium ion conductivity or reduction resistance of the nonaqueous electrolyte may be raised, this case is more preferable.

More preferably, when the cyclic carbonate making up the nonaqueous electrolyte is set as ethylene carbonate, and the linear carbonate is set as one kind or more of dimethyl carbonate and methyl ethyl carbonate, the lithium ion conductivity or the reduction resistance may be further raised.

In addition to this, propylene carbonate, butylene carbonate, diethyl carbonate, methyl acetate, or the like may be used as the nonaqueous solvent.

Furthermore, within a range not hindering the object of the invention, various kinds of additives may be added to the nonaqueous electrolyte, for example, ester phosphate or the like may be added to apply flame retardancy.

In the above-described embodiment, the lithium ion battery of this embodiment is made up by the high-potential cathode exhibiting a potential of 4.5 V or greater on the metallic lithium basis, the nonaqueous electrolyte, and the anode of this embodiment.

The high-potential cathode of this embodiment contains a cathode material that stably exhibits a potential of 4.5 V or greater on the metallic lithium basis.

Examples of the cathode material include, but are not particularly limited to, spinel-type oxides that are expressed by a general formula LiMn₂₋ₓMₓO₄, olivine-type oxides (ordinary name) that are expressed by a general formula of LiMPO₄ (M=Ni or Co), and the like. Spinel-type oxides having a compositional formula of Li₁₊ₐMn_{2-a-x-y}NiₓM_{y}O₄ (0≦a≦0.1, 0.3≦x≦0.5, 0≦y≦0.2, M is at least one kind of Cu, Co, Mg, Zn, and Fe) are preferable because these spinel-type oxides stably exhibit a potential of 4.5 V or greater with a high capacity.

The high-potential cathode of this embodiment is fabricated by using the cathode material, the conducting material, the binder, and the cathode collector.

As the conducting material, carbonaceous materials such as carbon black, hard carbon, soft carbon, and graphite may be used, but it is preferable to use the hard carbon together with the carbon black as necessary.

As the binder, high molecular resins such as polyvinylidene fluoride, polytetrafluoroethylene, a polyvinyl alcohol derivative, a cellulose derivative, and butadiene rubber may be used. When fabricating the cathode, this binder may be used in a state of being dissolved in a solvent such as N-methyl-2-pyrrolidone (NMP).

Solutions in which the cathode material, the conducting material, and the binder are respectively dissolved are weighed and mixed in such a manner that a desired mix composition is obtained, whereby cathode mix slurry is prepared. This slurry is applied onto the cathode collector such as aluminum foil. At this time, an uncoated portion in which a current taking-out terminal is to be provided is remained. After drying the slurry, the cathode collector is molded by a press, or cut into a desired size, whereby the high-potential cathode is fabricated.

As the cathode collector, the aluminum foil is preferably used. According to necessity, spraying of a dilute aqueous solution of the lithium fluoride on a surface of the cathode collector foil and drying thereof may be repeatedly performed so as to form the surface layer formed of the compound of lithium and fluorine.

The anode that is used in the lithium ion battery of this embodiment is configured as follows.

Examples of an anode material include, but are not limited to, various carbonaceous materials, metallic lithium, lithium titanate, oxides of tin, silicon, or the like, metals such as tin and silicon that may be alloyed with lithium, and composite materials using these materials. Particularly, in the carbonaceous materials such as graphite, soft carbon, and hard carbon, an exhibited potential is low and a cycle property is excellent, such that these carbonaceous materials are preferable as the anode active material that is used in the high-voltage lithium ion battery of this embodiment.

Solutions in which the anode material and the binder are respectively dissolved and the conducting material such as carbon black as necessary are weighed and mixed in such a manner that a desired mix composition is obtained, whereby anode mix slurry is prepared. This slurry is applied onto an anode collector such as copper foil and is dried. Then, the anode collector is molded by a press, or cut into a desired size, whereby the anode is fabricated.

Using the cathode, the anode, and the nonaqueous electrolyte of this embodiment as described so far, lithium ion batteries of this embodiment, which have shapes of a button type, a cylinder type, a square type, a laminate type, and the like, are fabricated.

A cylindrical battery is fabricated as follows.

A cathode and an anode, which are cut in a strip shape and in which an uncoated portion to provide a current taking-out terminal is remained, are used. A separator consisting of a porous insulating film having a thickness of 15 to 50 μm is interposed between the cathode and the anode. The resultant structure is wound into a cylindrical shape to fabricate a bundle of electrodes and this bundle of electrodes is contained in a container formed of SUS or aluminum. Porous insulating films formed of resins such as polyethylene, polypropylene, and aramid, or the porous insulating films provided with a layer of an inorganic compound such as alumina may be used as the separator.

A nonaqueous electrolyte is injected into the container accommodating the bundle of electrodes under a dry-air atmosphere or an inert gas atmosphere and this container is sealed off, whereby a cylindrical lithium ion battery is fabricated.

In addition, a square battery is fabricated, for example, as follows. In the above-described winding, winding axes are set to two in number, and an elliptical bundle of electrodes is fabricated. As is the case with the cylindrical lithium ion battery, this bundle is accommodated in a square container, an electrolyte is injected into the container, and then the container is sealed off. Instead of the winding, a bundle of electrodes obtained by stacking a separator, a cathode, a separator, an anode, and a separator in this order may also be used.

In addition, a laminate-type battery is fabricated, for example, as follows. The above-described stack type bundle of electrode is accommodated in a bag-like aluminum laminate sheet lined with an insulator sheet formed of polyethylene or polypropylene. An electrolyte is injected into the sheet in a state in which terminals of the electrodes are made to protrude from openings, and then the openings are sealed off.

No restrictions are imposed on the application of the lithium ion battery of this embodiment, but due to its high battery voltage, the battery is preferably used as a power supply in applications in which a plurality of batteries are used in multiple series. For example, the battery may be used as a power supply that supplies motive power for an electric vehicle (EV), a Hybrid-EV, or the like, a power supply for industrial equipments such as an elevator having a system that recovers at least a part of kinetic energy, and a power supply for an electrical power storage system used in various business applications or household applications.

For other applications, the battery may also be used as a power supply for various portable devices, information devices, household electrical machines, power tools, and the like.

Hereinafter, detailed examples of the lithium ion battery of this embodiment are shown and described in detail. Note that the invention is not restricted to the examples to be described below.

### EXAMPLES

Batteries A, B, and C that are batteries of this embodiment were fabricated as follows.

LiMn_{1.52}Ni_{0.48}O₄ was used as a cathode material exhibiting a potential of 4.5V or greater on the metallic lithium basis.

91% by weight of the cathode material, 3% by weight of carbon black, and a solution in which 6% by weight of polyvinylidene fluoride (PVDF) that is a binder was dissolved in N-methyl-2-pyrrolidone (NMP) were mixed to prepare cathode mix slurry. The cathode mix slurry was applied onto one surface of aluminum foil (cathode collector) having the thickness of 20 μm and this applied slurry was dried. Then, the slurry was similarly applied onto a rear surface and the applied slurry was dried. The weight of the dried mix was approximately 15 mg/cm² in one surface. Then, the cathode collector was cut into a size having a width of 54 mm and a length of 600 mm in such a manner that one side in the longitudinal direction was not coated with the slurry. The cathode collector was compressed and molded to a predetermined mix density with a press machine. Then, a cathode terminal formed of aluminum was welded to the uncoated portion, whereby a cathode was fabricated. Then, an anode was fabricated.

92% by weight of artificial graphite as an anode material and a solution in which 8% by weight of PVDF was dissolved in NMP were mixed to prepare anode mix slurry. This anode mix slurry was applied onto one surface of copper foil (anode collector) having the thickness of 15 μm and this applied slurry was dried. Then, the slurry was similarly applied onto a rear surface and this applied slurry was dried. The weight of the dried mix was approximately 7 mg/cm² in one surface. Then, the anode collector was cut into a size having a width of 56 mm and a length of 650 mm in such a manner that one side in the longitudinal direction was not coated with the slurry. The anode collector was compressed and molded to a predetermined mix density with a press machine. Then, an anode terminal formed of nickel was welded to the uncoated portion, whereby the anode was fabricated.

Using the fabricated cathode and anode, a cylindrical bundle of electrodes of the lithium ion battery that is schematically illustrated in FIG. 2 was fabricated. A cathode 12 and an anode 13 were wound with a porous separator 11, which has the thickness of 30 μm and which is formed of polypropylene, interposed between the cathode and the anode. At this time, a cathode terminal 14 and an anode terminal 15 were made to face opposite directions. The fabricated bundle of electrodes was impregnated with 5 cm³ of a nonaqueous electrolyte and was accommodated in a tubular laminate sheet formed of aluminum lined with polyethylene in an argon gas atmosphere. The cathode and anode terminals were made to protrude from openings at both ends and then the openings were sealed off, whereby the battery was fabricated.

The nonaqueous electrolyte was prepared as follows. 1 mol/dm³ of lithium hexafluorophosphate as a lithium salt was dissolved in a nonaqueous mixed solvent containing ethylene carbonate, dimethyl carbonate, and methyl ethyl carbonate in a volume ratio of 2:4:4. Then, 0.2% by weight (battery A), 1% by weight (battery B), and 4% by weight (battery C) of boron ethoxide (B(OC₂H₅)₃) were respectively added to the solvent, and these resultant solutions were used as the nonaqueous electrolyte.

### Comparative Examples

As comparative examples, a battery D using an electrolyte to which 6% by weight of boron ethoxide was added and a battery Z using an electrolyte to which no boron ethoxide was added were fabricated similarly to the embodiment except for the above-described difference.

### Charge and Discharge Test

Charge and discharge tests were performed using two respective fabricated battery cells of the examples and comparative examples.

The charge conditions are as follows. Each cell was charged with a constant current at a C-rate of 1/5 CA as a charge current to a final voltage of 4.85 V. Immediately thereafter, constant-voltage charge was performed for 1 hour at a voltage of 4.85 V. After the charge, a circuit was kept open for 30 minutes. The discharge conditions were as follows. Each cell was discharged with a constant current at a C-rate of 1/5 CA as a discharge current to a final voltage of 3 V. After the discharge, the circuit was kept open for 30 minutes. A set of the charge and discharge as described above was defined as one cycle.

Each one of the battery cells of the examples and comparative examples was tested up to 5 cycles and was subjected to XPS measurement. The other cells were tested up to 40 cycles. The discharge capacity of each battery cell after 1 cycle and charge capacity and discharge capacity after 40 cycles were measured.

### XPS Measurement of Cathode Collector

The XPS measurement of the cathode collector was performed as follows.

The bundle of electrodes was taken out from each battery cell that was undergone 5 cycles of the charge and discharge tests in an argon gas atmosphere, and the cathode was taken out from the bundle of electrodes. A collector that is an uncoated portion and has the dimensions of approximately 1 cm² was cut out. This collector piece was cleaned in dimethyl carbonate and was dried. Then, this collector piece was transported into a photoemission spectrometer (AXIS-HS manufactured by SHIMADSU/KARATOS Co., Ltd, in which a target is Al, a tube voltage is 15 kV, and a tube current is 15 mA) while not exposed to the air.

A measured surface of the collector piece was etched with argon ions at an acceleration voltage of 2.5 kV for 1 minutes (corresponds to removal of approximately 4 nm in terms of a silicon oxide) and then XPS was measured.

Proportions of elements Li, F, and Al, and an element other than these elements were obtained on the basis of a peak intensity area of a spectrum of each element that was detected and sensitivity coefficient thereof. In addition, the sensitivity coefficient was calculated in advance on the basis of a peak intensity area when a material whose composition is known is measured. In addition, after a bonding energy value was corrected on the basis of a peak position of a C—H bond in a C1s spectrum, a bonding energy value (main peak position) in peaks of Li1s and F1s spectrums was obtained.

Table 1 shows a proportion of elements on a surface of the cathode collector, a main peak position, a ratio of the discharge capacity after 40 cycles with respect to the discharge capacity after 1 cycle, and a coulombic efficiency after 40 cycles (ratio of the discharge capacity with respect to the charge capacity) in the XPS measurement on each battery of the examples and the comparative examples.

In the battery of the examples, lithium and fluorine were detected from the surface of the cathode collector. In regard to proportions of these elements, a proportion of Li was ½ or less with respect to that of Al that is an element making up the collector, a proportion of F was equal to or less than that of Al. On the other hand, in regard to proportions of elements of the battery D of the comparative example, a proportion of Li exceeds 1/2 of that of Al, and a proportion of F exceeds that of Al. In addition, lithium was not detected from the surface of the cathode collector of the comparative battery Z.

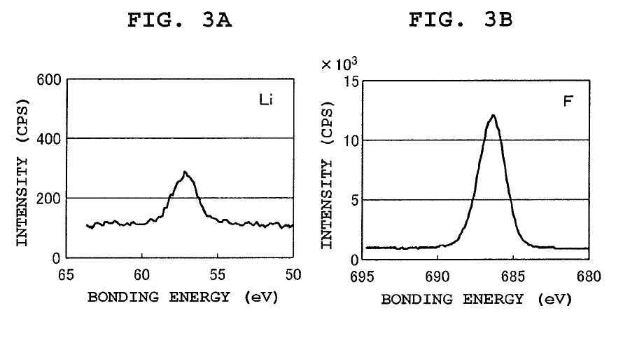

In all batteries, a main peak position of Li1s was in a range of 56 to 57.5 eV, and a main peak position of F1s was within a range of 685.5 to 686.5 eV. For reference, an Li1s waveform and an F1s waveform in the battery C are shown in FIG. 3.

According to the batteries of the examples, an effect described below was obtained. That is, the discharge capacity and coulombic efficiency after 40 cycles were higher than those of the batteries of the comparative examples, and the cycle lifetime was excellent compared to the comparative examples.

TABLE 1

| | | Proportion of elements (%) | | | | Main peak position (eV) | | Cycle capacity | Cycle coulombic |
|---|---|---|---|---|---|---|---|---|---|
| | Battery | Li | F | Al | Others | Li1s | F1s | (%) | efficiency (%) |
| Examples | Battery A | 6 | 12 | 64 | 18 | 56.5 | 685.8 | 85.7 | 99.27 |
| | Battery B | 8 | 14 | 60 | 18 | 56.1 | 685.8 | 86.5 | 99.39 |
| | Battery C | 16 | 30 | 38 | 16 | 57.1 | 686.1 | 86.3 | 99.18 |
| Comparative | Battery D | 20 | 40 | 25 | 15 | 56.9 | 686.0 | 83.8 | 98.59 |
| Examples | Battery Z | Not-detected | 5 | 69 | 26 | — | 686.2 | 79.3 | 96.61 |

### Reference Examples

Batteries M and N that are batteries using LiMn_{1/3}Ni_{1/3}CO_{1/3}O₂ that is a cathode active material operating at a potential that is less than 4.5 V on the metallic lithium basis were fabricated as reference examples in the same way as the examples. The battery M used an electrolyte to which no boron ethoxide was added, and the battery N used an electrolyte to which 1% by weight of boron ethoxide was added.

Using the fabricated batteries of the reference examples, charge and discharge tests similar to the tests for the examples were conducted up to 40 cycles. The charge conditions were as follows. Constant-current charge was performed at a charge current at a C-rate of 1/5 CA to a final voltage of 4.1 V. Immediately thereafter, constant-voltage charge was performed at a voltage of 4.1 V for 1 hour. The final voltage of the discharge was set to 2.7 V.

Table 2 shows proportions of elements on a surface of a cathode collector and a position of main peak in the XPS measurement, a ratio of the discharge capacity after 40 cycles with respect to the discharge capacity after 1 cycle, and a coulombic efficiency of each battery of the reference examples.

The battery N to which boron ethoxide was added was slightly lower in the discharge capacity after 40 cycles and in the coulombic efficiency than the battery M to which no boron ethoxide was added, and there was no effect on the cycle lifetime. In addition, lithium was not detected from the surface of the cathode collector of each battery.

TABLE 2

| | | Proportion of elements (%) | | | | Main peak position (eV) | | Cycle capacity | Cycle coulombic |
|---|---|---|---|---|---|---|---|---|---|
| | Battery | Li | F | Al | Others | Li1s | F1s | (%) | efficiency (%) |
| Reference | Battery M | Not-detected | 4 | 80 | 16 | — | 686.4 | 96.4 | 99.83 |
| Examples | Battery N | Not-detected | 5 | 78 | 17 | — | 686.5 | 95.7 | 99.74 |

1. A lithium ion battery, comprising:
a cathode that includes a cathode mix, which contains a cathode material exhibiting a potential of 4.5 V or greater on a metallic lithium basis, a conducting material, and a binder, on a cathode collector;
an anode; and
a nonaqueous electrolyte that is obtained by dissolving a lithium salt in a nonaqueous solvent,
wherein a compound of lithium and fluorine is provided on a surface layer of the cathode collector.

2. The lithium ion battery according to claim 1,
wherein the compound of lithium and fluorine is a lithium fluoride.

3. The lithium ion battery according to claim 1,
wherein in measurement of the cathode collector according to X-ray photoelectron spectroscopy (XPS), an Li1s waveform is present, and in the Li1s waveform, a main peak is shown at 56 to 57.5 electron volt (eV).

4. The lithium ion battery according to claim 3,
wherein in the measurement of the cathode collector according to the X-ray photoelectron spectroscopy (XPS), a waveform of F1s is present, and in the waveform of F1s, a main peak is shown at 685.5 to 686.5 electron volt (eV).

5. The lithium ion battery according to claim 1,
wherein the lithium salt is lithium hexafluorophosphate.

6. The lithium ion battery according to claim 1,
wherein the nonaqueous solvent contains cyclic carbonate and linear carbonate.

7. The lithium ion battery according to claim 6
wherein the cyclic carbonate is ethylene carbonate, and the linear carbonate is at least one of dimethyl carbonate and methyl ethyl carbonate.
